(19) United States
(12) Patent Application Publication
(10) Pub. No.: US 2018/0213564 A1
(43) Pub. Date: Jul. 26, 2018

(54) Method and Apparatus for Sending Signal by Using Unlicensed Carrier

(71) Applicant: ZTE CORPORATION, Shenzhen City, Guangdong Province (CN)

(72) Inventors: Hanqing XU, Shenzhen (CN); Yajun ZHAO, Shenzhen (CN); Linmei MO, Shenzhen (CN)

(21) Appl. No.: 15/747,767

(22) PCT Filed: Apr. 8, 2016
(86) PCT No.: PCT/CN2016/078854

§ 371 Date: Jan. 26, 2018

(30) Foreign Application Priority Data
Jul. 30, 2015 (CN) 201510458853.4

(51) Int. Cl. H04W 74/08; H04W 16/14; H04W 28/26

(52) U.S. Cl. CPC H04W 74/0808; H04W 28/26; H04W 16/14

(57) ABSTRACT

Provided is a method for sending a signal by using an unlicensed carrier. The method includes: processing a designated reference signal to carry identification information of an operator; and sending the designated reference signal on a time domain and/or a frequency domain by using an unlicensed carrier.

### TECHNICAL FIELD

The present application relates to, but not limited to, the field of radio communications, and more particularly to a method and apparatus for sending a signal by using an unlicensed carrier.

### BACKGROUND

Long Term Evolution-Unlicensed (LTE-U) refers to deployment of LTE in an unlicensed carrier to meet increasing capacity demands of a radio communication system and to improve the using efficiency of an unlicensed spectrum, which is a possible important evolution direction of LTE and future radio communications. During design of the LTE-U, it is required to consider how to fairly and friendly contend for an unlicensed carrier with an inter-system such as Wireless Fidelity (WiFi) and radar and as well as an LTE-U intra-system to perform data transmission, and meanwhile, it is required to avoid influence on and to retain LTE technical characteristics as much as possible. According to the presentation of a 3rd Generation Partnership Project (3GPP) standard conference, an LTE-U system may also be referred to as an LTE Licensed Assisted Access (LAA) system.

It is required to avoid from using an unlicensed carrier, currently used by an existing station, in unlicensed carriers for a communication system using the unlicensed carriers. Otherwise, mutual interferences among systems will be caused. Therefore, in some countries (such as Europe and Japan), a Listen before Talk (LBT) function is forcibly required to be supported on the unlicensed carrier. Before a certain unlicensed carrier is used, it is required to execute a Clear Channel Assessment (CCA) function. If it is discovered that a device is currently using this unlicensed carrier or that detected signal energy exceeds a CCA threshold, access is delayed. If it is discovered that a channel is a clear channel or that detected signal energy is lower than the CCA threshold, this unlicensed carrier is occupied. In addition, it is also required to meet a limitation that an occupied bandwidth must be greater than or equal to 80% of a nominal bandwidth.

It is likewise required to solve the problems of cell discovery and synchronization and the like during using of the unlicensed carrier. A base station or cell may send a Primary/Secondary Synchronization Signal (PSS/SSS) or send a Discovery Reference Signal (DRS, DRS including PSS/SSS) to implement cell discovery or synchronization. However, for either the former or the latter (PSS/SSS and PSS/SSS in DRS have the same pattern substantially), the PSS/SSS only occupies six Resource Blocks (RBs) (or 7 RBs, usually 6 RBs) in the middle of a system bandwidth, including ten subcarriers 0 at both sides, about 1.08 MHz. In case of no data transmission, there is a problem that an occupied bandwidth does not meet requirements of an unlicensed carrier, that is, a requirement that an occupied bandwidth must be greater than or equal to 80% of a nominal bandwidth cannot be met. The current 3GPP specifies that an LAA bandwidth in a Rel-13 (Release 13) is not smaller than 5 MHz. Therefore, even if an LAA nominal bandwidth is 5 MHz, PSS/SSS transmission does not meet the requirement that an occupied bandwidth is greater than or equal to 80% of a nominal bandwidth.

Because different operators may use the same Physical-layer Cell-Identity (PCID) when using an unlicensed carrier cell, the problem of confusions of PCIDs (two identical Physical-Layer Cells (PCI) do not have an overlapped coverage area) or collisions of PCIDs (two identical PCIs have an overlapped coverage area) will be caused. Therefore, it is required to send an operator Identifier (ID) such as a Public Land Mobile Network (PLMN) ID to a User Equipment (UE), and then the UE can correctly distinguish whether two identical PCID cells pertain to an operator serving itself or other operators. The related solution proposes that the UE is explicitly notified of a PLMN ID by means of control information. However, that not only increases signaling overheads, but also faces the problem of demodulation. Sending and demodulation performances of a demodulation reference signal are also involved. Therefore, the related solution is very complicated.

### SUMMARY

The following is a brief introduction for a subject described herein in detail. The brief introduction is not intended to restrict the scope of protection of claims.

Embodiments of the present disclosure provide a method and apparatus for sending a signal by using an unlicensed carrier, intended to solve the problem of collisions of PCIDs whilst meeting limitation requirements of an occupied bandwidth.

An embodiment of the present disclosure provides a method for sending a signal by using an unlicensed carrier. The method includes the steps as follows.

A designated reference signal is processed to carry identification information of an operator.

The designated reference signal is sent on a time domain and/or a frequency domain by using an unlicensed carrier.

In an exemplary embodiment, the above-mentioned method also has the following characteristics: the designated reference signal is processed to carry the identification information of the operator in the following manner:

filling control information on a reserved subcarrier in an RB occupied by the designated reference signal, the control information including identification information of the operator.

In an exemplary embodiment, the above-mentioned method also has the following characteristics: the manner of filling control information on a reserved subcarrier in an RB occupied by the designated reference signal includes:

for a single unlicensed carrier, filling the control information on a reserved subcarrier/subcarriers in one or more RBs occupied by the designated reference signal; or, filling the control information only on a reserved subcarrier in a designated RB in a middle of a system bandwidth occupied by the designated reference signal; or, filling the control information on a reserved subcarrier/subcarriers in other RBs other than a designated RB in a middle of a system bandwidth occupied by the designated reference signal.

In an exemplary embodiment, the above-mentioned method also has the following characteristics: the manner of filling control information on a reserved subcarrier in an RB occupied by the designated reference signal includes:

for multiple unlicensed carriers, filling the control information on each of the multiple unlicensed carriers; or, filling the control information on one or more of the multiple unlicensed carriers.

In an exemplary embodiment, the above-mentioned method also has the following characteristics: the control information includes one or more of the following:

a Public Land Mobile Network Identifier (PLMN ID), an Evolved Universal Terrestrial Radio Access Network (E-UTRAN) Cell Global Identifier (ECGI), an operating carrier, a carrier using situation, neighbor cell frequency wave using related information, a Listen before Talk (LBT) parameter, an occupied time length, resource mapping information, a subframe number, a System Frame Number (SFN), a starting position of data, and a starting position of a signal.

In an exemplary embodiment, the above-mentioned method also has the following characteristics: the designated reference signal is processed to carry the identification information of the operator in the following manner:

coding the designated reference signal by using the identification information of the operator.

In an exemplary embodiment, the above-mentioned method also has the following characteristics: the designated reference signal is sent on a time domain by using the unlicensed carrier in the following manner:

continuously sending the reference signal; or,

sending coded reference signal at an interval of one or more symbols; or,

sending the reference signal for multiple times on multiple symbols of a subframe, the multiple symbols being adjacent or spaced by one or more symbols; or,

sending the reference signal on limited to one or more subframes in a frame; or, sending the reference signal on any one subframe in a frame.

In an exemplary embodiment, the above-mentioned method also has the following characteristics:

if the reference signal is not sent on continuous symbols, other reference signals, or data, or control information or reserved signals are filled on a middle symbol.

In an exemplary embodiment, the above-mentioned method also has the following characteristics: the coded reference signal is sent on a frequency domain by using the unlicensed carrier in the following manner:

the reference signal being continuous or spaced at an interval of one or more Resource Elements (RE) or RBs.

In an exemplary embodiment, the above-mentioned method also has the following characteristics: the reference signal is sent on a frequency domain by using the unlicensed carrier in the following manners:

filling the reference signal from a middle of a system bandwidth to both sides; or,

filling the reference signal from a low frequency band to a high frequency band of a system bandwidth.

In an exemplary embodiment, the above-mentioned method also has the following characteristics: the identification information of the operator includes any one of the following:

a Mobile Network Code (MNC), a PLMN ID, an ECGI, and re-numbered operator identification information.

In an exemplary embodiment, the above-mentioned method also has the following characteristics: the designated reference signal includes:

a PSS and/or an SSS in an unlicensed carrier; or,

a PSS and/or an SSS in a DRS or an initial signal or a reserved signal.

In an exemplary embodiment, the above-mentioned method also has the following characteristics: the designated reference signal includes one or more of the following:

a PSS, an SSS, a Common Reference Signal (CRS), a Channel State Information-Reference Signal (CSI-RS), a Positioning Reference Signal (PRS), and a Downlink User Equipment-specific Reference Signal (DMRS).

An embodiment of the present disclosure provides an apparatus for sending a signal by using an unlicensed carrier. The apparatus includes a processing module and a sending module.

The processing module is configured to process a designated reference signal to carry identification information of an operator.

The sending module is configured to send the designated reference signal on a time domain and/or a frequency domain by using an unlicensed carrier.

In an exemplary embodiment, the above-mentioned apparatus also has the following characteristics:

the processing module processes a designated reference signal to carry identification information of an operator in the following manner: filling control information on a reserved subcarrier in an RB occupied by the designated reference signal, herein the control information includes the identification information of the operator.

In an exemplary embodiment, the above-mentioned apparatus also has the following characteristics.

The processing module fills control information on a reserved subcarrier in an RB occupied by the designated reference signal in the following manner:

for a single unlicensed carrier, filling the control information on a reserved subcarrier/subcarriers in one or more RBs occupied by the designated reference signal for a single unlicensed carrier; or, filling the control information only on a reserved subcarrier in a designated RB in the middle of a system bandwidth occupied by the designated reference signal; or, filling the control information on a reserved subcarrier/subcarriers in other RBs other than a designated RB in the middle of a system bandwidth occupied by the designated reference signal.

In an exemplary embodiment, the above-mentioned apparatus also has the following characteristics.

The processing module fills control information on a reserved subcarrier in an RB occupied by the designated reference signal in the following manners:

for multiple unlicensed carriers, filling the control information on each of the multiple unlicensed carriers; or, filling the control information on one or more of unlicensed carriers.

Herein, the control information includes one or more of the following: a PLMN ID, an ECGI, an operating carrier, a carrier using situation, neighbor cell frequency wave using related information, an LBT parameter, an occupied time length, resource mapping information, a subframe number, an SFN, a starting position of data, and a starting position of a signal.

In an exemplary embodiment, the above-mentioned apparatus also has the following characteristics:

the processing module processes a designated reference signal to carry identification information of an operator in the following manner: coding the designated reference signal by using the identification information of the operator.

In an exemplary embodiment, the above-mentioned apparatus also has the following characteristics.

The sending module sends the reference signal on a time domain by using an unlicensed carrier in the following manners:

continuously sending the reference signal; or,

sending coded reference signal at an interval of one or more symbols; or,

sending the reference signal for multiple times on multiple symbols of a subframe, the multiple symbols being adjacent or spaced by one or more symbols; or,

sending the reference signal on limited to one or more subframes in a frame; or,

sending the reference signal on any one subframe in a frame.

If the reference signal is not sent on continuous symbols, other reference signals, or data, or control information or reserved signals are filled on a middle symbol.

In an exemplary embodiment, the above-mentioned apparatus also has the following characteristics.

The sending module sends the reference signal on a frequency domain by using an unlicensed carrier in the following manners: the reference signal being continuous or spaced at an interval of one or more REs or RBs.

In an exemplary embodiment, the above-mentioned apparatus also has the following characteristics.

The sending module sends the reference signal on a frequency domain by using an unlicensed carrier in the following manners: filling the reference signal from the middle of a system bandwidth to both sides; or, filling the reference signal from a low frequency band to a high frequency band of a system bandwidth.

In an exemplary embodiment, the above-mentioned apparatus also has the following characteristics:

the identification information of the operator includes any one of the following: an MNC, a PLMN ID, an ECGI, and re-numbered operator identification information; and

the designated reference signal includes one or more of the following: a PSS, an SSS, a CRS, a CSI-RS, a PRS, and a DMRS.

In addition, an embodiment of the present disclosure also provides a computer-readable storage medium, which stores a computer-executable instruction. When the computer-executable instruction is executed, the above-mentioned method for sending a signal by using an unlicensed carrier is implemented.

To sum up, the embodiments of the present disclosure provide a method and apparatus for sending a signal by using an unlicensed carrier, capable of effectively solving the problem of failing to meet requirements of an occupied bandwidth in an unlicensed carrier and the problem of collisions and confusions of cell PCIDs, and capable of further improving the detection performance of a cell.

After the drawings and the detailed descriptions are read and understood, other aspects can be understood.

### BRIEF DESCRIPTION OF DRAWINGS

FIG. 1 is a flowchart of a method for sending a signal by using an unlicensed carrier according to an embodiment of the present disclosure.

FIG. 2 is a schematic diagram of application occasion one according to embodiment one of the present disclosure.

FIG. 3 is a schematic diagram of application occasion two according to embodiment one of the present disclosure.

FIG. 4 is a schematic diagram of application occasion one according to embodiment two of the present disclosure.

FIG. 5 is a schematic diagram of application occasion two according to embodiment two of the present disclosure.

FIG. 6 is a schematic diagram of application occasion one according to embodiment three of the present disclosure.

FIG. 7 is a schematic diagram of application occasion two according to embodiment three of the present disclosure.

FIG. 8 is a schematic diagram of an apparatus for sending a signal by using an unlicensed carrier according to an embodiment of the present disclosure.

### DETAILED DESCRIPTION

Embodiments of the present disclosure will be described below with the drawings in detail. It is important to note that the embodiments in the present application and the features in the embodiments may be randomly combined with one another under the condition of no conflicts.

A synchronization signal PSS/SSS may be independently sent to achieve cell discovery and synchronization functions, or may serve as a composition signal of a DRS, or may serve as a composition signal of an initial signal/reserved signal independently or in combination with other signals to achieve a channel reservation function and other assistant functions. The synchronization signal in the embodiments of the present disclosure is applied to the above different application occasions.

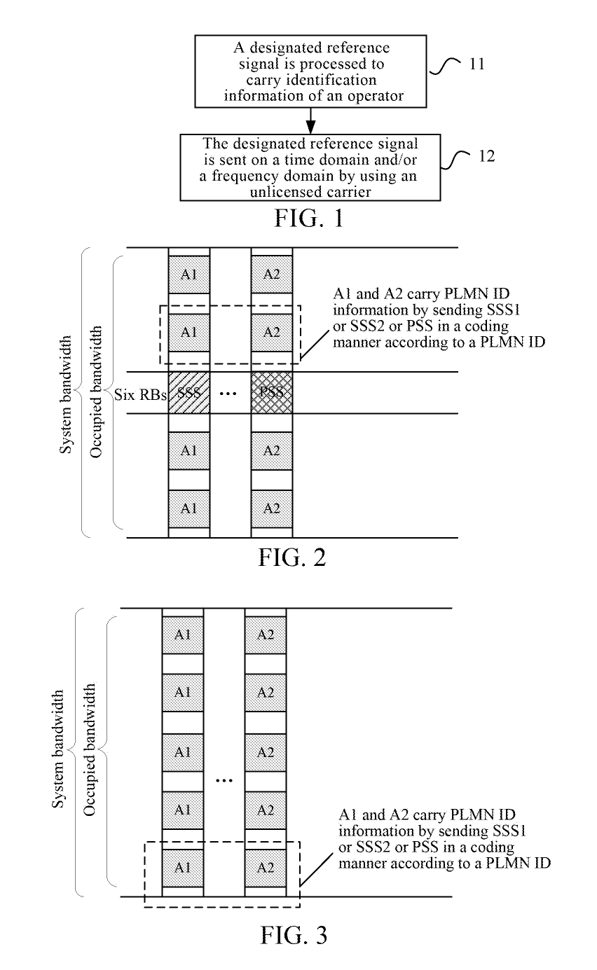

FIG. 1 is a flowchart of a method for sending a signal by using an unlicensed carrier according to an embodiment of the present disclosure. As shown in FIG. 1, the method of the present embodiment includes the steps 11-12 as follows.

In step 11, a designated reference signal is processed to carry identification information of an operator.

In step 12, the designated reference signal is sent on a time domain and/or a frequency domain by using an unlicensed carrier.

The identification information of the operator may be used for identification through an MNC, a PLMN, an ECGI, and re-numbered operator identifiers, or may be other equivalent operator identification information.

In an alternative embodiment, a designated reference signal is processed to carry identification information of an operator in the following manner:

coding the designated reference signal by using identification information of the operator.

In an alternative embodiment, a designated reference signal is processed to carry identification information of an operator in the following manner:

filling control information on a reserved subcarrier in an RB occupied by the designated reference signal, herein the control information includes identification information of the operator.

Herein, the control information may include one or more of the following: a PLMN, an ECGI, an operating carrier, a carrier using situation, neighbor cell frequency wave using related information, an LBT parameter, an occupied time length, resource mapping information, a subframe number, an SFN, a starting position of data or a signal, and the like.

In an alternative embodiment, the designated reference signal may include:

a PSS and/or an SSS in an unlicensed carrier; or,

a PSS and/or an SSS in a DRS or an initial signal or a reserved signal.

In an alternative embodiment, the designated reference signal includes one or more of the following:

a PSS, an SSS, a CRS, a CSI-RS, a PRS, and a DMRS.

In the embodiments of the present disclosure, how to code and send an SSS and a PSS according to a PLMN (the same manner may be adopted for an MNC and an ECGI) is illustrated with the PLMN as an example, and how a UE judges an operator to which a downlink signal pertains according to the received SSS and PSS is illustrated.

The above-mentioned method can meet requirements of an unlicensed carrier about an occupied bandwidth, and further improve the detection performance of a synchronization signal.

LTE defines 504 different PCIDs in total, herein each PCID corresponds to a specific downlink reference signal sequence. A PCID set is further divided into 168 cell ID groups, and each group contains three cell IDs.

To assist in cell searching, LTE specifies two special signals: a PSS and an SSS. Time domain positions of the PSS and the SSS in a frame are different, which depend on a Frequency Division Duplex (FDD) mode or a Time Division Duplex (TDD) mode adopted by a cell.

Under the FDD mode, the SSS and the PSS are sent on a symbol 5 and a symbol 6 in a subframe 0 (or subframe 5) respectively, that is, the SSS and the PSS are continuously sent on a time domain. Under the TDD mode, the PSS is sent on the third symbol (namely symbol 2) of a subframe 1 and a subframe 6, and the SSS is sent on the last symbol of the subframe 0 and the subframe 5, that is, the SSS is sent in advance of the PSS by three symbols, and the SSS and the PSS are not continuously sent on the time domain.

In a cell, two PSSs in a frame are the same, and PSSs of a cell may take a value from three values, depending on a PCID of this cell. Each SSS may take a value from 168 different values corresponding to 168 different cell ID groups. However, two SSSs in a frame have different values, SSS1 is in a subframe 0, SSS2 is in a subframe 5, and SSS1 and SSS2 have different values. Therefore, when a UE receives a PSS, 5ms timing may be obtained, and when receiving SSS1 or SSS2, frame timing may be obtained.

An unlicensed carrier has a special characteristic: if a blank exists between two transmissions, and the right of using the unlicensed carrier may be taken away by other devices. Therefore, after the unlicensed carrier is contended, it is better to continuously send a signal or a channel. Hence, for LAA, the positions of the SSS and the PSS may be adjusted or redesigned.

For example, for the synchronization signal in an unlicensed carrier or the synchronization signal in a DRS (or reserved signal), the SSS and PSS may not be forcibly sent on a subframe 0 and a subframe 5. Or, the SSS and the PSS may not be forcibly sent on subframes 0, 1, 5 and 6. For another example, for the unlicensed carrier it may not be distinguished whether a sending mode is FDD or TDD, and the SSS and the PSS may be sent by specifying the same pattern. For another example, the SSS and the PSS may be forced to be continuously sent, or other reference signals (such as CRS) or control information or data may be sent on a blank symbol between the SSS and the PSS.

Therefore, in the embodiments of the present disclosure, the SSS and the PSS may be sent on continuous symbols (such as the existing FDD solution), or may be sent at an interval of two symbols (such as the existing TDD solution), or may be sent at an interval of other number of symbols. Other reference signals (such as CRS) or control information or data may be sent on a blank symbol between the SSS and the PSS. SSS symbols may be ahead of PSS symbols or may be behind the PSS symbols. Even, the SSS and/or the PSS may be repeatedly sent on multiple symbols in a subframe. These symbols may be adjacent, or may be spaced by one or more symbols. The above-mentioned SSS and PSS sending manners may be applied to independent sending of the SSS and the PSS in an unlicensed carrier, or applied to sending of the SSS and the PSS in a DRS, or applied to sending of the SSS and the PSS in a reserved signal/initial signal, and the effect of retaining an unlicensed carrier or improving the detection ability can be achieved.

The solution in the embodiments of the present disclosure is illustrated with specific embodiments below.

### Embodiment One

On a time domain, an SSS (including SSS1 and SSS2) and/or a PSS are coded according to operator ID information to carry the operator ID information (such as PLMN ID), and the coded SSS and/or PSS are repeatedly sent on other blank resources on the time domain and/or the frequency domain to meet requirements of an unlicensed carrier about an occupied bandwidth. The above-mentioned method further improves the detection performance of the synchronization signal.

Two methods or application occasions are present in the present embodiment.

Application Occasion One

As shown in FIG. 2, a PSS and/or an SSS, or a PSS and/or an SSS in a DRS or a reserved signal are sent still normally on six middle RBs of a system bandwidth. Sending in a coding manner is not carried out on these resources. One or more signals of PSS, SSS1 and SSS2 are sent on other time/frequency domain blank resources rather than resources corresponding to the above-mentioned PSS and/or SSS Orthogonal Frequency Division Multiplexing (OFDM) symbols according to a coding pattern to carry PLMN ID information, and requirements of an unlicensed carrier about an occupied bandwidth are met, and the detection performance of a synchronization signal is further improved. As shown in FIG. 2, an SSS and/or a PSS are sent on six middle RBs of the system bandwidth for cell discovery and synchronization. The SSS and the PSS may be sent in accordance with the following rules.

On a time domain, the SSS and the PSS may be sent continuously (on adjacent symbols), or may be sent at an interval of one or more symbols. SSS symbols may be ahead of PSS symbols or may be behind the PSS symbols. The SSS and/or the PSS may be sent for multiple times on multiple symbols in a subframe. These symbols may be adjacent, or may be spaced by one or more symbols. The SSS and the PSS may be sent on limited to one or more subframes in a frame, or, may be sent on any one subframe in a frame.

If the SSS and the PSS are not sent on continuous symbols, other reference signals, or data, or control information or reserved signals or the like need to be filled on the middle symbols. Otherwise, it is possible that the right of using an unlicensed carrier is taken away by other adjacent devices.

SSS1 and/or SSS2 and/or PSS may be sent on time domain and frequency domain blank resources corresponding to SSS and PSS OFDM symbols according to a coding pattern. The SSS1 and/or the SSS2 and/or the PSS are all a 62-bit sequence, and have ten subcarriers 0 at both sides. Therefore, an OFDM symbol is occupied respectively on the time domain, and six RBs are occupied on the frequency domain.

On the frequency domain, every two SSSs/PSSs may be continuous or spaced at an interval of one or more REs or RBs. The size of a frequency domain interval is associated with a system bandwidth, an occupied bandwidth, and/or the number of SSSs/PSSs that can be arranged. For example, as shown in FIG. 2, two adjacent A1s, or A1 and an adjacent SSS (sent on six middle RBs), or two adjacent A2s, or A2 and an adjacent PSS (sent on six middle RBs) may be continuous on the frequency domain, or at an interval of one or more REs or RBs.

For example, a system nominal bandwidth of 5M usually contains 25 RBs (or 27.5 RBs, depending on different definition manners, not influencing implementation of the embodiments of the present disclosure) on the frequency domain. By taking 25 RBs as an example, 80% of the nominal bandwidth is 20 RBs, so the occupied bandwidth needs to be greater than or equal to 20 RBs.

An SSS and a PSS are sent on six middle RBs of the system bandwidth. The SSS and/or the PSS may be sent at A1 and A2 positions at an upward interval of an RB. The SSS and/or the PSS may be sent at A1 and A2 positions at a downward interval of an RB. The occupied bandwidth totally includes 20 RBs (6 RB+1 RB*2+6 RB*2).

Or, an SSS and/or a PSS are sent on six middle RBs of the system bandwidth at an upward interval of two RBs and at a downward interval of two RBs. The occupied bandwidth totally includes 22 RBs (6 RB+2 RB*2+6 RB*2).

Or, A1 and an SSS, and A2 and a PSS are spaced by other number of RBs or REs. However, the occupied bandwidth cannot be greater than the system nominal bandwidth, or cannot be smaller than 80% of the nominal bandwidth.

Each filled SSS/PSS (A1 and A2 in FIG. 2) may be filled from the middle of the system bandwidth to both sides, or may be filled from a low frequency band to a high frequency band of the system bandwidth, and so on.

For example, for a system bandwidth of 5M, A1 and A2 may be sent on six middle RBs of a system once at an upward interval of one or more REs/RBs, and A1 and A2 may be sent on six middle RBs of the system once at a downward interval of one or more REs/RBs. A1 and A2 may be repeatedly sent twice.

For a system bandwidth of above 5M, A1 and A2 may be sent repeatedly for many times (A1 and A2 in FIG. 2 are sent repeatedly for four times).

In a mobile network, PLMN=MCC+MNC, where a Mobile Country Code (MCC) is three figures usually, and for example, the MCC of China is 460. An MNC is combined with the MCC to represent the unique mobile device network operator. The MNC is allocated by the country where the mobile device network operator is located, and usually consists of two to three figures. For example, a GSM MNC of China Mobile Communication Corporation is 00, and a GSM MNC of China Unicom is 01. Therefore, PLMNs of two operators (GSM) are 46000 and 46001. Because LAA is designed based on LTE, it is only required to carry or send a PLMN ID of an LTE network of an operator usually.

For example, as shown in FIG. 2, two OFDM symbols are occupied in a subframe on a time domain by an SSS and a PSS, and SSS1 and/or SSS2 and/or PSS may be coded and sent on frequency domain blank resources corresponding to the two symbols. A1 and A2 may carry PLMN ID information by sending SSS1 and/or SSS2 and/or PSS in a coding manner according to a PLMN ID on the time domain. A1 and A2 are repeatedly sent on other time domain and frequency domain blank resources to meet requirements of an occupied bandwidth and to further improve the detection performance of a synchronization signal.

SSS1, SSS2 and PSS may be sent at A1 and A2 positions; or, only two of them may be allowed to be sent, for example, only SSS1 and SSS2 may be sent, namely, PSS does not sent in a coding manner; or, only one of them may be sent, for example only PSS is sent, and in this time, A1 and A2 need to be distinguished by different PSS sequences.

For example, PLMN ID information may be carried in the following coding manner (actually, it is only required to represent PLMN IDs associated with LAA, the following is only exemplary, here SSS1, SSS2 and PSS all participate in sending in a code manner):

PLMN=46000, {A1, A2}={SSS1, SSS1},

PLMN=46001, {A1, A2}={SSS1, SSS2},

PLMN=46002, {A1, A2}={SSS1, PSS},

PLMN=46003, {A1, A2}={SSS2, SSS1},

PLMN=46004, {A1, A2}={SSS2, SSS2},

PLMN=46005, {A1, A2}={SSS2, PSS},

PLMN=46006, {A1, A2}={PSS, SSS1},

PLMN=46007, {A1, A2}={PSS, SSS2},

PLMN=46008, {A1, A2}={PSS, PSS}.

An operator ID may be re-numbered. For example, a modulo or re-numbering operation is performed on the operator ID. A1 and A2 are sent according to the re-defined operator ID.

For example, a new ID of an operator=mod (PLMN, 46000). If a PLMN of a certain operator=46003, the new ID of the operator=3. If a PLMN of a certain operator=46007, a new ID of the operator=7.

Or, to save number resources and reduce the number of operator IDs required to be carried, the operator ID may be re-numbered. If a PLMN of a certain operator=46003, a new ID of the operator=1. If a PLMN of a certain operator=46007, a new ID of the operator=2, and so on. A PLMN ID not associated with LTE or LAA does not need to be numbered.

Each new ID of an operator corresponds to a sending manner for A1 and A2. When receiving sequences at corresponding positions of A1 and A2, a UE may determine an operator from which a signal comes. Here, it is not forcibly required that the UE can definitely conclude a specific PLMN number or an ECGI number, and it is required that the UE can judge an operator to which a signal pertains according to the received sequence.

If an operator PLMN ID of LAA is 46001, LAA will send SSS1 at an A1 position in FIG. 2, and send SSS2 at an A2 position. After receiving the signal, the UE will judge timing and a PCID according to an SSS and a PSS sent on six middle RBs, and will obtain operator ID information according to the SSS1 and the SSS2 sent at the Al and A2 positions. Therefore, a unique cell ID can be obtained (that is, which cell corresponding to which operator can be determined).

If multiple SSSs or multiple PSSs are sent in a DRS occasion or a reserved signal occasion during design of a DRS or a reserved signal, more PLMN IDs may be represented. For example, if two symbol SSSs and a symbol PSS may be sent in a DRS occasion, SSS1 and/or SSS2 and/or PSS may be coded and sent on frequency domain blank resources corresponding to the three symbols. Likewise, the operation may be executed in a manner of coding on a time domain and repeating on a frequency domain.

For example, PLMN ID information may be carried in the following coding manner (actually, it is only required to represent PLMN IDs associated with LAA):

PLMN=46000, {A1, A2, A3}={SSS1, SSS1, SSS1},

PLMN=46001, {A1, A2, A3}={SSS1, SSS1, SSS2},

. . . , . . .

PLMN=46026, {A1, A2, A3}={PSS, PSS, PSS}.

Application Occasion Two

Each composition signal of a DRS and/or a reserved signal may not be continuously sent, and one or more blank OFDM symbols may be present between every two composition signals. SSS1 and/or SSS2 and/or PSS are coded and sent on these OFDM symbols, including six middle RBs of a system bandwidth, to carry PLMN ID information and fill an occupied bandwidth. As shown in FIG. 3, SSS1 and/or SSS2 and/or PSS are coded and sent on blank symbols on a time domain, and these SSSs or PSSs sent in accordance with the above-mentioned rule may be repeatedly sent on time domain and frequency domain blank resources to meet requirements of an occupied bandwidth.

On a frequency domain, every two SSSs/PSSs may be continuous or spaced at an interval of one or more REs or RBs. The size of a frequency domain interval is associated with a system bandwidth, an occupied bandwidth, and/or the number of SSSs/PSSs that can be arranged. For example, as shown in FIG. 3, two adjacent A1s, or two adjacent A2s may be sent on the frequency domain continuously, or at an interval of one or more REs or RBs.

For example, as shown in FIG. 3, two blank symbols which may be continuous or non-continuous are present in a DRS or transmission burst. SSS1 and/or SSS2 and/or PSS may be coded and sent on time domain and frequency domain blank resources corresponding to the two symbols to retain a right of using a channel or carrier. A1 and A2 may carry PLMN ID information by sending SSS1 and/or SSS2 and/or PSS in a coding manner according to a PLMN ID on a time domain. A1 and A2 are repeatedly sent on other time domain and frequency domain blank resources to meet requirements of an occupied bandwidth and to further improve the detection performance of a synchronization signal.

For example, PLMN ID information may be carried in the following coding manner (actually, it is only required to represent PLMN IDs associated with LAA):

PLMN=46000, {A1, A2}={SSS1, SSS1},

PLMN=46001, {A1, A2}={SSS1, SSS2},

PLMN=46002, {A1, A2}={SSS1, PSS},

PLMN=46003, {A1, A2}={SSS2, SSS1},

PLMN=46004, {A1, A2}={SSS2, SSS2},

PLMN=46005, {A1, A2}={SSS2, PSS},

PLMN=46006, {A1, A2}={PSS, SSS1},

PLMN=46007, {A1, A2}={PSS, SSS2},

PLMN=46008, {A1, A2}={PSS, PSS}.

That is, if an operator PLMN ID of LAA is 46001, in FIG. 3 LAA will send SSS1 at an A1 position, and send SSS2 at an A2 position. After receiving a signal, the UE will judge timing and a PCID according to an SSS and a PSS sent on six middle RBs, and will obtain PLMN ID information according to the SSS1 and the SSS2 sent at the A1 and A2 positions. Therefore, a unique cell ID can be obtained.

If multiple blank symbols are present in a DRS or transmission burst (there are six blank symbols in a current Rel-12 DRS), then more PLMN IDs may be represented. For example, if three blank symbols are present in a DRS, then SSS1 and/or SSS2 and/or PSS may be coded and sent on frequency domain blank resources corresponding to the three symbols. Likewise, the operation may be executed in a manner of coding on a time domain and repeating on a frequency domain.

For example, PLMN ID information may be carried in the following coding manner (actually, it is only required to represent PLMN IDs associated with LAA):

PLMN=46000, {A1, A2, A3}={SSS1, SSS1, SSS1},

PLMN=46001, {A1, A2, A3}={SSS1, SSS1, SSS2},

. . . , . . .

PLMN=46026, {A1, A2, A3}={PSS, PSS, PSS}.

### Embodiment two

On a frequency domain, an SSS (including SSS1 and SSS2) and/or a PSS are coded according to operator ID information to carry the operator ID information (such as PLMN ID), and the coded SSS and/or PSS are repeatedly sent on time domain and/or frequency domain blank resources to meet requirements of an occupied bandwidth. The above-mentioned method further improves the detection performance of a synchronization signal.

Two methods or application occasions are present in the present embodiment.

Application Occasion One

As shown in FIG. 4, a PSS and/or an SSS, or a PSS and/or an SSS in a DRS or a reserved signal are sent still normally on six middle RBs of a system bandwidth. Sending in a coding manner is not carried out on these resources. One or more signals of PSS, SSS1 and SSS2 are sent on other time/frequency domain blank resources corresponding to PSS and/or SSS OFDM symbols according to a coding pattern to carry PLMN ID information, and requirements of an unlicensed carrier about an occupied bandwidth are met, and the detection performance of a synchronization signal is further improved.

Other contents are roughly the same as the application occasion one in the embodiment one.

As shown in FIG. 4, an SSS and/or a PSS are sent on six middle RBs of a system bandwidth for cell discovery and synchronization. The SSS and the PSS may be sent in accordance with the following rules.

On a time domain, the SSS and the PSS may be sent continuously (on adjacent symbols), or may be sent at an interval of one or more symbols. SSS symbols may be ahead of PSS symbols or may be behind the PSS symbols. The SSS and/or the PSS may be sent for multiple times on multiple symbols in a subframe. These symbols may be adjacent, or may be spaced by one or more symbols. The SSS and the PSS may be sent on limited to one or more subframes in a frame, or, may be sent on any one subframe in a frame.

If the SSS and the PSS are not sent on continuous symbols, other reference signals, or data, or control information or reserved signals or the like need to be filled on the middle symbols. Otherwise, it is possible that the right of using an unlicensed carrier is taken away by other adjacent devices.

SSS1 and/or SSS2 and/or PSS may be sent on time domain and frequency domain blank resources corresponding to SSS and PSS OFDM symbols according to a coding pattern. The SSS1 and/or the SSS2 and/or the PSS are all a 62-bit sequence, and have ten subcarriers 0 at both sides. Therefore, an OFDM symbol is occupied respectively on the time domain, and six RBs are occupied on the frequency domain.

On the frequency domain, every two SSSs/PSSs may be continuous or spaced at an interval of one or more REs or RBs. The size of a frequency domain interval is associated with a system bandwidth, an occupied bandwidth, and/or the number of SSSs/PSSs that can be arranged. For example, as shown in FIG. 4, A1 and an adjacent A2, or A1 and an adjacent SSS, or A1 and an adjacent PSS may be continuous on the frequency domain, or at an interval of one or more REs or RBs.

Each filled SSS/PSS (A1 and A2 in FIG. 4) may be filled from the middle of the system bandwidth to both sides, or may be filled from a low frequency band to a high frequency band of the system bandwidth.

For example, as shown in FIG. 4, two OFDM symbols are occupied in a subframe on a time domain by an SSS and a PSS, and SSS1 and/or SSS2 and/or PSS may be coded and sent on frequency domain blank resources corresponding to the two symbols. A1 and A2 may carry PLMN ID information by sending SSS1 and/or SSS2 and/or PSS in a coding manner according to a PLMN ID on a frequency domain. A1 and A2 are repeatedly sent on other time domain and frequency domain blank resources to meet requirements of an occupied bandwidth and to further improve the detection performance of a synchronization signal.

For example, PLMN ID information may be carried in the following coding manner (actually, it is only required to represent PLMN IDs associated with LAA):

PLMN=46000, {A1, A2}={SSS1, SSS1},

PLMN=46001, {A1, A2}={SSS1, SSS2},

PLMN=46002, {A1, A2}={SSS1, PSS},

PLMN=46003, {A1, A2}={SSS2, SSS1},

PLMN=46004, {A1, A2}={SSS2, SSS2},

PLMN=46005, {A1, A2}={SSS2, PSS},

PLMN=46006, {A1, A2}={PSS, SSS1},

PLMN=46007, {A1, A2}={PSS, SSS2},

PLMN=46008, {A1, A2}={PSS, PSS}.

That is, if an operator PLMN ID of LAA is 46001, in FIG. 4 LAA will send SSS1 at an A1 position, and send SSS2 at an A2 position. After receiving a signal, the UE will judge timing and a PCID according to an SSS and a PSS sent on six middle RBs, and will obtain PLMN ID information according to the SSS1 and the SSS2 sent at the A1 and A2 positions. Therefore, a unique cell ID can be obtained.

If multiple SSSs or multiple PSSs are sent in a DRS occasion or a reserved signal occasion during design of a DRS or a reserved signal, more PLMN IDs may be represented. For example, if two symbol SSSs and a symbol PSS may be sent in a DRS occasion, SSS1 and/or SSS2 and/or PSS may be coded and sent on frequency domain blank resources corresponding to the three symbols. Likewise, the operation may be executed in a manner of coding on a time domain and repeating on a frequency domain.

For example, PLMN ID information may be carried in the following coding manner (actually, it is only required to represent PLMN IDs associated with LAA):

PLMN=46000, {A1, A2, A3}={SSS1, SSS1, SSS1},

PLMN=46001, {A1, A2, A3}={SSS1, SSS1, SSS2},

. . . , . . .

PLMN=46026, {A1, A2, A3}={PSS, PSS, PSS}.

Application Occasion Two

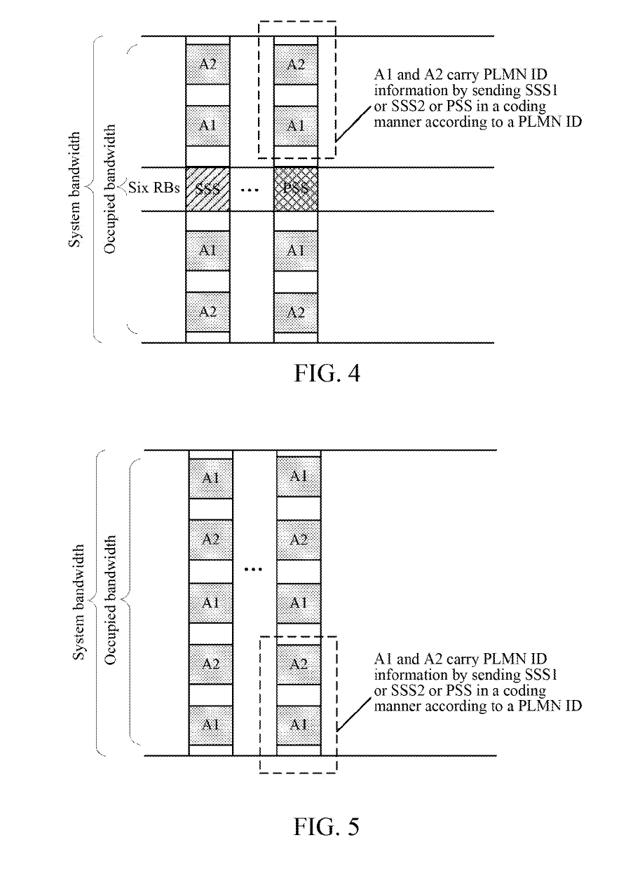

Each composition signal of a DRS and/or a reserved signal may not be continuously sent, and one or more blank OFDM symbols may be present between every two composition signals. SSS1 and/or SSS2 and/or PSS are coded and sent on these OFDM symbols, including six middle RBs of a system bandwidth, to carry PLMN ID information and fill an occupied bandwidth. As shown in FIG. 5, SSS1 and/or SSS2 and/or PSS are coded and sent on blank symbols on a frequency domain, and these SSSs or PSSs sent in accordance with the above-mentioned rule may be repeatedly sent on other time domain and frequency domain blank resources to meet requirements of an occupied bandwidth.

On a frequency domain, every two SSSs/PSSs may be continuous or spaced at an interval of one or more REs or RBs. The size of a frequency domain interval is associated with a system bandwidth, an occupied bandwidth, and/or the number of SSSs/PSSs that can be arranged. For example, as shown in FIG. 5, two adjacent A1s may be continuous on the frequency domain, or spaced at an interval of one or more REs or RBs.

For example, as shown in FIG. 5, two blank symbols which may be continuous or non-continuous are present in a DRS or transmission burst. SSS1 and/or SSS2 and/or PSS may be coded and sent on time domain and frequency domain blank resources corresponding to the two symbols to retain a right of using a channel or carrier. A1 and A2 may carry PLMN ID information by sending SSS1 and/or SSS2 and/or PSS in a coding manner according to a PLMN ID on a time domain. A1 and A2 are repeatedly sent on other time domain and frequency domain blank resources to meet requirements of an occupied bandwidth and to further improve the detection performance of a synchronization signal.

For example, PLMN ID information may be carried in the following coding manner (actually, it is only required to represent PLMN IDs associated with LAA):

PLMN=46000, {A1, A2}={SSS1, SSS1},

PLMN=46001, {A1, A2}={SSS1, SSS2},

PLMN=46002, {A1, A2}={SSS1, PSS},

PLMN=46003, {A1, A2}={SSS2, SSS1},

PLMN=46004, {A1, A2}={SSS2, SSS2},

PLMN=46005, {A1, A2}={SSS2, PSS},

PLMN=46006, {A1, A2}={PSS, SSS1},

PLMN=46007, {A1, A2}={PSS, SSS2},

PLMN=46008, {A1, A2}={PSS, PSS}.

That is, if an operator PLMN ID of LAA is 46001, in FIG. 5 LAA will send SSS1 at an A1 position, and send SSS2 at an A2 position. After receiving a signal, the UE will judge timing and a PCID according to an SSS and a PSS sent on six middle RBs, and will obtain PLMN ID information according to the SSS1 and the SSS2 sent at the A1 and A2 positions. Therefore, a unique cell ID can be obtained.

If multiple blank symbols are present in a DRS or transmission burst (there are six blank symbols in a current Rel-12 DRS), then more PLMN IDs may be represented. For example, if three blank symbols are present in a DRS, then SSS1 and/or SSS2 and/or PSS may be coded and sent on frequency domain blank resources corresponding to the three symbols. Likewise, the operation may be executed in a manner of coding on a time domain and repeating on a frequency domain.

For example, PLMN ID information may be carried in the following coding manner (actually, it is only required to represent PLMN IDs associated with LAA):

PLMN=46000, {A1, A2, A3}={SSS1, SSS1, SSS1},

PLMN=46001, {A1, A2, A3}={SSS1, SSS1, SSS2},

. . . , . . .

PLMN=46026, {A1, A2, A3}={PSS, PSS, PSS}.

### Embodiment Three

On a time domain and a frequency domain, an SSS (including SSS1 and SSS2) and/or a PSS are coded according to operator ID information to carry the operator ID information (PLMN ID), and the coded SSS and/or PSS are repeatedly sent on other blank resources on the time domain and the frequency domain to meet requirements of an occupied bandwidth. The above-mentioned method further improves the detection performance of a synchronization signal.

Two methods or application occasions are present in the present embodiment.

Application Occasion Oone

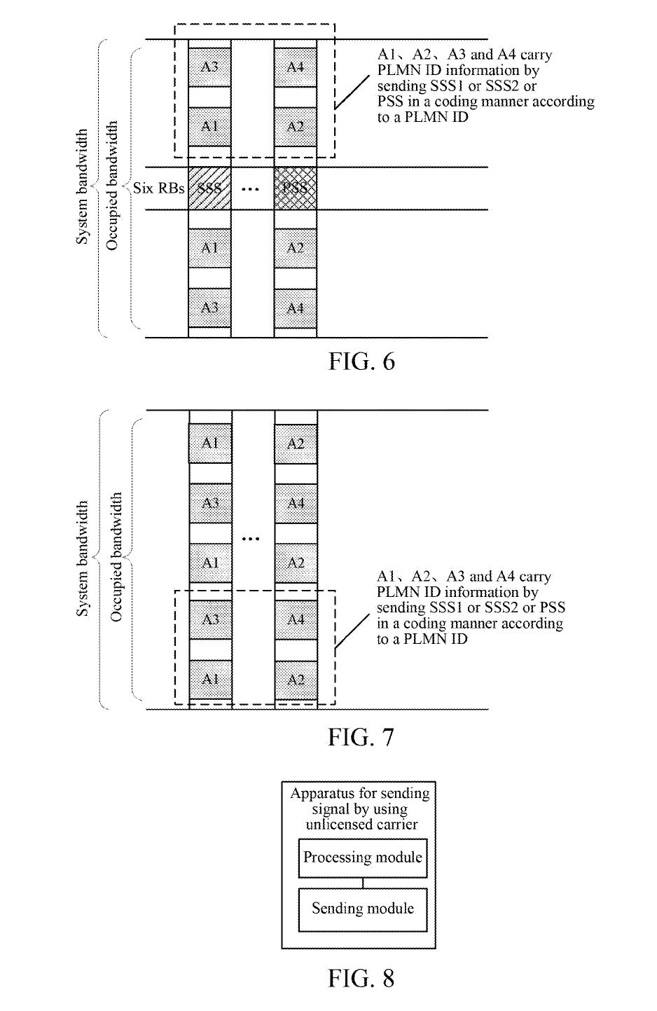

As shown in FIG. 6, a PSS and/or an SSS, or a PSS and/or an SSS in a DRS or a reserved signal are sent still normally on six middle RBs of a system bandwidth. Sending in a coding manner is not carried out on these resources. PSS and/or SSS1 and/or SSS2 are sent on other time/frequency domain blank resources corresponding to PSS and/or SSS OFDM symbols according to a coding pattern to carry PLMN ID information, and requirements of an unlicensed carrier about an occupied bandwidth are met, and the detection performance of a synchronization signal is further improved.

As shown in FIG. 6, an SSS and/or a PSS are sent on six middle RBs of a system bandwidth for cell discovery and synchronization. The SSS and the PSS may be sent in accordance with the following rules.

On the time domain, the SSS and the PSS may be sent continuously (on adjacent symbols), or may be sent at an interval of one or more symbols. SSS symbols may be ahead of PSS symbols or may be behind the PSS symbols. The SSS and/or the PSS may be sent for multiple times on multiple symbols in a subframe. These symbols may be adjacent, or may be spaced by one or more symbols. The SSS and the PSS may be sent on limited to one or more subframes in a frame, or, may be sent on any one subframe in a frame.

If the SSS and the PSS are not sent on continuous symbols, other reference signals, or data, or control information or reserved signals or the like need to be filled on the middle symbols. Otherwise, it is possible that the right of using an unlicensed carrier is taken away by other adjacent devices.

SSS1 and/or SSS2 and/or PSS may be sent on frequency domain blank resources corresponding to SSS and PSS OFDM symbols according to a coding pattern. The SSS1 and/or the SSS2 and/or the PSS are all a 62-bit sequence, and have ten subcarriers 0 at both sides. Therefore, an OFDM symbol is occupied respectively on the time domain, and six RBs are occupied on the frequency domain.

On the frequency domain, every two SSSs/PSSs may be continuous or spaced at an interval of one or more REs or RBs. The size of a frequency domain interval is associated with a system bandwidth, an occupied bandwidth, and/or the number of SSSs/PSSs that can be arranged. For example, as shown in FIG. 6, A1 and an adjacent A3, or A2 and an adjacent A4, or A1 and an adjacent SSS, or A2 and an adjacent PSS may be continuous on the frequency domain, or spaced at an interval of one or more REs or RBs.

In addition, codes of the SSS and/or the PSS on the time and frequency domains may be arranged according to positions in FIG. 6, that is, A1, A2, A3 and A4 may be arranged in a manner as shown in FIGS. 6. A1, A2, A3 and A4 may be arranged by taking six middle RBs of the system as an axis of symmetry. A1, A2, A3 and A4 may be sent by filling and coding from a low frequency band to a high frequency band of a system bandwidth, and so on.

For example, as shown in FIG. 6, two OFDM symbols are occupied in a subframe on a time domain by an SSS and a PSS, and SSS1 and/or SSS2 and/or PSS may be coded and sent on time domain and frequency domain blank resources corresponding to the two symbols. A1, A2, A3 and A4 may carry PLMN ID information by sending SSS1 and/or SSS2 and/or PSS in a coding manner according to a PLMN ID on a frequency domain. A1, A2, A3 and A4 are repeatedly sent on other time domain and frequency domain blank resources to meet requirements of an occupied bandwidth and to further improve the detection performance of a synchronization signal.

For example, PLMN ID information may be carried in the following coding manner (actually, it is only required to represent PLMN IDs associated with LAA):

PLMN=46000, {A1, A2, A3, A4}={SSS1, SSS1, SSS1, SSS1},

PLMN=46001, {A1, A2, A3, A4}={SSS1, SSS1, SSS1, SSS2},

PLMN=46002, {A1, A2, A3, A4}={SSS1, SSS1, SSS1, PSS},

. . . , . . .

PLMN=46080, {A1, A2, A3, A4}={PSS, PSS, PSS, PSS}.

That is, if an operator PLMN ID of LAA is 46001, in FIG. 6 LAA will send SSS1 at an A1 position, send SSS1 at an A2 position, send SSS1 at an A3 position, and send SSS2 at an A4 position. After receiving a signal, the UE will judge timing and a PCID according to an SSS and a PSS sent on six middle RBs, and will obtain PLMN ID information according to the SSS1 and the SSS2 sent at the A1, A2, A3 and A4 positions. Therefore, a unique cell ID can be obtained.

Application Occasion Two

Each composition signal of a DRS and/or a reserved signal may not be continuously sent, and one or more blank OFDM symbols may be present between every two composition signals. SSS1 and/or SSS2 and/or PSS are coded and sent on these OFDM symbols, including six middle RBs of a system bandwidth, to carry PLMN ID information and fill an occupied bandwidth. As shown in FIG. 7, SSS1 and/or SSS2 and/or PSS are coded and sent on blank symbols on a frequency domain, and these SSSs or PSSs sent in accordance with the above-mentioned rule may be repeatedly sent on other time domain and frequency domain blank resources to meet requirements of an occupied bandwidth.

On a frequency domain, every two SSSs/PSSs may be continuous or spaced at an interval of one or more REs or RBs. The size of a frequency domain interval is associated with a system bandwidth, an occupied bandwidth, and/or the number of SSSs/PSSs that can be arranged. For example, as shown in FIG. 7, A1 and an adjacent A3, or A2 and an adjacent A4 may be continuous on the frequency domain, or spaced at an interval of one or more REs or RBs.

For example, as shown in FIG. 7, two blank symbols which may be continuous or non-continuous are present in a DRS or transmission burst. SSS1 and/or SSS2 and/or PSS may be coded and sent on time domain and frequency domain blank resources corresponding to the two symbols to retain a right of using a channel or carrier. A1 and A2 may carry PLMN ID information by sending SSS1 and/or SSS2 and/or PSS in a coding manner according to a PLMN ID on a time domain. A1 and A2 are repeatedly sent on other time domain and frequency domain blank resources to meet requirements of an occupied bandwidth and to further improve the detection performance of a synchronization signal.

For example, PLMN ID information may be carried in the following coding manner (actually, it is only required to represent PLMN IDs associated with LAA):

PLMN=46000, {A1, A2, A3, A4}={SSS1, SSS1, SSS1, SSS1},

PLMN=46001, {A1, A2, A3, A4}={SSS1, SSS1, SSS1, SSS2},

PLMN=46002, {A1, A2, A3, A4}={SSS1, SSS1, SSS1, PSS},

. . . , . . .

PLMN=46080, {A1, A2, A3, A4}={PSS, PSS, PSS, PSS}.

That is, if an operator PLMN ID of LAA is 46001, in FIG. 7 LAA will send SSS1 at an A1 position, send SSS1 at an A2 position, send SSS1 at an A3 position, and send SSS2 at an A4 position. After receiving a signal, the UE will judge timing and a PCID according to an SSS and a PSS sent on six middle RBs, and will obtain PLMN ID information according to the SSS1 and the SSS2 sent at the A1, A2, A3 and A4 positions. Therefore, a unique cell ID can be obtained.

In addition, similarly, it may be considered that other reference signals are coded and sent or sent in a sending pattern on frequency domain blank resources on SSS and PSS symbols or non-continuous blank symbols in a DRS or transmission burst in an application occasion of an unlicensed carrier, to retain a right of using the unlicensed carrier or carry control information or meet specified requirements of an occupied bandwidth. These reference signals coded and sent or sent in a sending pattern to meet the above-mentioned function may include a CRS, a CSI-RS, a PRS, a DMRS and the like, that is, the reference signals are not limited to the PSS/SSS.

### Embodiment Four

Six RBs (or seven RBs, usually six RBs, taking six RBs as an example in the embodiments of the present disclosure) in the middle of a system bandwidth are occupied by a PSS/SSS, and the PSS/SSS totally occupies 72 subcarriers, including ten subcarriers 0 at both sides (the ten subcarriers are reserved currently, and not used to send the PSS/SSS).

Time frequency resources may be filled by using the PSS and/or the SSS. Filling methods may include two methods. The first method is consistent with the method of the above-mentioned embodiments one to three. In the first method, the PSS and/or the SSS are coded and sent to carry control information such as operator ID information, and a coded sequence is repeated sent on the time frequency resources to ensure requirements of an occupied bandwidth. In the second method, a coding manner may not be adopted, and only the PSS and/or the SSS are sent simply and repeatedly. For example, if the PSS is sent on six RBs in the middle of a system bandwidth of a certain OFDM symbol, the PSS is repeatedly sent on frequency domain resources corresponding to this symbol to ensure to meet requirements of the system bandwidth. For another example, if the SSS is sent on six RBs in the middle of a system bandwidth of a certain OFDM symbol, the SSS is repeatedly sent on frequency domain resources corresponding to this symbol to ensure to meet requirements of the system bandwidth.

Control information is sent by using ten subcarriers 0 at both sides of each PSS and/or SSS. Herein, the control information may include one or more of the following: a PLMN, an ECGI, an operating carrier, a carrier using situation, neighbor cell frequency wave using related information, an LBT parameter, a signal length, resource mapping information, a subframe number, an SFN, a starting position of data or a signal, and the like.

The control information in the present embodiment may be filled in the following manners.

For a single unlicensed carrier (such as an unlicensed carrier of 5 MHz or 20 MHz),

the control information may be filled on ten reserved subcarriers of one or more PSSs and/or SSSs, and other PSSs and/or SSSs are repeatedly sent or not filled.

Or, the control information is not filled on ten reserved subcarriers of PSSs and/or SSSS of six middle RBs of the system bandwidth (no change, the same as the existing pattern), and the control information is sent on ten reserved subcarriers of PSSs and/or SSSs at other positions.

Or, the control information is filled only on ten reserved subcarriers of PSSs and/or SSSs of six middle RBs of the system bandwidth, and the control information is not filled on ten reserved subcarriers 0 of PSSs and/or SSSs at other positions.

The control information is filled on ten subcarriers 0 of PSSs and/or SSSS of six middle RBs of the system bandwidth, and other control signals such as a CRS or a CSI-RS or a DMRS are filled at other positions of a frequency domain to meet requirements of an occupied bandwidth.

For multiple unlicensed carriers (such as multiple unlicensed carriers of 5 MHz or 20 MHz),

the control information may be sent on each unlicensed carrier, herein the sending manner is carried out as above; or,

the control information may be sent on one or more of the multiple unlicensed carriers, and the control information is not sent on other unlicensed carriers, and the control information on these carriers is sent by the one or more of the multiple unlicensed carriers. For example, the control information is sent only on a main carrier.

FIG. 8 is a schematic diagram of an apparatus for sending a signal by using an unlicensed carrier according to an embodiment of the present disclosure. As shown in FIG. 8, the apparatus of the present embodiment includes a processing module and a sending module.

The processing module is configured to process a designated reference signal to carry identification information of an operator.

The sending module is configured to send the designated reference signal on a time domain and/or a frequency domain by using an unlicensed carrier.

In an alternative embodiment, the processing module processes a designated reference signal to carry identification information of an operator in the following manner: filling control information on a reserved subcarrier in an RB occupied by the designated reference signal. Herein, the control information includes identification information of the operator.

In an alternative embodiment, the processing module fills control information on a reserved subcarrier in an RB occupied by the designated reference signal in the following manners: for a single unlicensed carrier, filling the control information on a reserved subcarrier/subcarriers in one or more RBs occupied by the designated reference signal; or, filling the control information only on a reserved subcarrier in a designated RB in the middle of a system bandwidth occupied by the designated reference signal; or, filling the control information on a reserved subcarrier/subcarriers in other RBs other than a designated RB in the middle of a system bandwidth occupied by the designated reference signal.

In an alternative embodiment, the processing module fills the control information on a reserved subcarrier in an RB occupied by the designated reference signal in the following manners: for multiple unlicensed carriers, filling the control information on each of the multiple unlicensed carriers; or, filling the control information on one or more of unlicensed carriers.

In an alternative embodiment, the processing module processes a designated reference signal to carry identification information of an operator in the following manner: coding the designated reference signal by using identification information of the operator.

In an alternative embodiment, the sending module sends the reference signal on a time domain by using an unlicensed carrier in the following manners: continuously sending the reference signal; or, sending coded reference signal at an interval of one or more symbols; or, sending the reference signal for multiple times on multiple symbols of a subframe, the multiple symbols being adjacent or spaced by one or more symbols; or, sending the reference signal on limited to one or more subframes in a frame; or, sending the reference signal on any one subframe in a frame. If the reference signal is not sent on continuous symbols, other reference signals, or data, or control information or reserved signals are filled on a middle symbol.

In an alternative embodiment, the sending module sends the coded reference signal on a frequency domain by using an unlicensed carrier in the following manner: the reference signal being continuous or spaced at an interval of one or more REs or RBs.

In an alternative embodiment, the sending module sends the reference signal on a frequency domain by using an unlicensed carrier in the following manners: filling the reference signal from the middle of a system bandwidth to both sides; or, filling the reference signal from a low frequency band to a high frequency band of a system bandwidth.

In an alternative embodiment, the identification information of the operator includes any one of the following: an MNC, a PLMN ID, an ECGI, and re-numbered operator identification information. The designated reference signal includes one or more of the following: a PSS, an SSS, a CRS, a CSI-RS, a PRS, and a DMRS.

In addition, an embodiment of the present disclosure also provides a computer-readable storage medium, which stores a computer-executable instruction. When the computer-executable instruction is executed, the above-mentioned method for sending a signal by using an unlicensed carrier in the above-mentioned embodiments is implemented.

Those of ordinary skill in the art may understand that all or some of the steps in the above-mentioned methods may be completed by instructing relevant hardware (e.g., processor) through a program. The program may be stored in a computer-readable storage medium such as a read-only memory, a magnetic disk or an optical disk or the like. In an exemplary embodiment, all or some of the steps in the above-mentioned embodiments may be also implemented by using one or more integrated circuits. Accordingly, each module/unit in the above-mentioned embodiments may be implemented in a form of hardware. For example, corresponding functions thereof are implemented by means of an integrated circuit, and each module/unit may also be implemented in a form of software function module. For example, corresponding functions thereof are implemented by executing programs/instructions stored in a memory by the processor. The present application is not limited to the combination of hardware and software in any specific form.

The above embodiments are only the alternative embodiments of the present application. Certainly, the present application may also have various embodiments. Those skilled in the art may make various corresponding changes and transformations according to the present application without departing from the rule and essence of the present application. However, these corresponding changes and transformations should fall within the scope of protection of the appended claims of the present application.

### INDUSTRIAL APPLICABILITY

The embodiments of the present disclosure provide a method and apparatus for sending a signal by using an unlicensed carrier, capable of effectively solving the problem of failing to meet requirements of an occupied bandwidth in an unlicensed carrier and the problem of collisions and confusions of cell PCIDs, and capable of further improving the detection performance of a cell.

What is claimed is:

1. A method for sending a signal by using an unlicensed carrier, comprising:
processing a designated reference signal to carry identification information of an operator; and
sending the designated reference signal on a time domain and/or a frequency domain by using the unlicensed carrier.

2. The method according to claim 1, wherein the processing a designated reference signal to carry identification information of an operator in a following manner:
filling control information on a reserved subcarrier in a Resource Block, RB, occupied by the designated reference signal, the control information comprising the identification information of the operator.

3. The method according to claim 2, wherein the filling control information on a reserved subcarrier in an RB occupied by the designated reference signal comprises:
for a single unlicensed carrier, filling the control information on a reserved subcarrier/subcarriers in one or more RBs occupied by the designated reference signal; or, filling the control information only on a reserved subcarrier in a designated RB in a middle of a system bandwidth occupied by the designated reference signal; or, filling the control information on a reserved subcarrier/subcarriers in other RBs other than a designated RB in a middle of a system bandwidth occupied by the designated reference signal.

4. The method according to claim 3, wherein the filling control information on a reserved subcarrier in an RB occupied by the designated reference signal comprises:
for multiple unlicensed carriers, filling the control information on each of the multiple unlicensed carriers; or, filling the control information on one or more of the multiple unlicensed carriers.

5. The method according to claim 2, wherein the control information comprises one or more of:
a Public Land Mobile Network Identifier, PLMN ID, an Evolved Universal Terrestrial Radio Access Network, E-UTRAN, Cell Global Identifier, ECGI, an operating carrier, a carrier using situation, neighbor cell frequency wave using related information, a Listen before Talk, LBT, parameter, an occupied time length, resource mapping information, a subframe number, a System Frame Number, SFN, a starting position of data, and a starting position of a signal.

6. The method according to claim 1, wherein the processing a designated reference signal to carry identification information of an operator in a following manner:
coding the designated reference signal by using the identification information of the operator.

7. The method according to claim 1, wherein the sending the designated reference signal on a time domain by using the unlicensed carrier in following manners:
continuously sending the reference signal; or,
sending coded reference signal at an interval of one or more symbols; or,
sending the reference signal for multiple times on multiple symbols of a subframe, the multiple symbols being adjacent or spaced by one or more symbols; or,
sending the reference signal on limited to one or more subframes in a frame; or, sending the reference signal on any one subframe in a frame.

8. The method according to claim 7, wherein if the reference signal is not sent on continuous symbols, other reference signals, or data, or control information or reserved signals are filled on a middle symbol.

9. The method according to claim 1, wherein the sending the reference signal on a frequency domain by using the unlicensed carrier in following manners:
the reference signal being continuous or spaced at an interval of one or more Resource Elements, REs or RBs.

10. The method according to claim 1, wherein the sending the reference signal on a frequency domain by using the unlicensed carrier in following manners:
filling the reference signal from a middle of a system bandwidth to both sides; or,
filling the reference signal from a low frequency band to a high frequency band of a system bandwidth.

11. The method according to claim 1, wherein the identification information of the operator comprises any one of:
a Mobile Network Code, MNC, a PLMN ID, an ECGI, and re-numbered operator identification information.

12. The method according to claim 1, wherein the designated reference signal comprises:
a Primary Synchronization Signal, PSS, and/or a Secondary Synchronization Signal, SSS, in an unlicensed carrier; or,
a PSS and/or an SSS in a Discovery Reference Signal, DRS, or an initial signal or a reserved signal;
or
the designated reference signal comprises one or more of:
a PSS, an SSS, a Common Reference Signal, CRS, a Channel State Information-Reference Signal, CSI-RS, a Positioning Reference Signal, PRS, and a Downlink User Equipment-specific Reference Signal.

13. (canceled)

14. An apparatus for sending a signal by using an unlicensed carrier, comprising:
a processing module, configured to process a designated reference signal to carry identification information of an operator; and
a sending module, configured to send the designated reference signal on a time domain and/or a frequency domain by using the unlicensed carrier.

15. The apparatus according to claim 14, wherein the processing module processes a designated reference signal to carry identification information of an operator in a following manner: filling control information on a reserved subcarrier in a Resource Block, RB, occupied by the designated reference signal, wherein the control information comprises the identification information of the operator.

16. The apparatus according to claim 15, wherein the processing module fills control information on a reserved subcarrier in an RB occupied by the designated reference signal in following manners:
for a single unlicensed carrier, filling the control information on a reserved subcarrier/subcarriers in one or more RBs occupied by the designated reference signal; or, filling the control information only on a reserved subcarrier in a designated RB in a middle of a system bandwidth occupied by the designated reference signal; or, filling the control information on a reserved subcarrier/subcarriers in other RBs other than a designated RB in the middle of a system bandwidth occupied by the designated reference signal.

17. The apparatus according to claim 16, wherein the processing module fills control information on a reserved subcarrier in an RB occupied by the designated reference signal in following manners:
for multiple unlicensed carriers, filling the control information on each of the multiple unlicensed carriers; or, filling the control information on one or more of unlicensed carriers,
wherein, the control information comprises one or more of: a Public Land Mobile Network Identifier, PLMN ID, an Evolved Universal Terrestrial Radio Access Network, E-UTRAN, Cell Global Identifier, ECGI, an operating carrier, a carrier using situation, neighbor cell frequency wave using related information, a Listen before Talk, LBT, parameter, an occupied time length, resource mapping information, a subframe number, a System Frame Number, SFN, a starting position of data, and a starting position of a signal.

18. The apparatus according to claim 16, wherein the processing module processes a designated reference signal to carry identification information of an operator in a following manner: coding the designated reference signal by using the identification information of the operator.

19. The apparatus according to claim 14, wherein the sending module sends the reference signal on a time domain by using the unlicensed carrier in following manners:
continuously sending the reference signal; or,
sending coded reference signal at an interval of one or more symbols; or,
sending the reference signal for multiple times on multiple symbols of a subframe, the multiple symbols being adjacent or spaced by one or more symbols; or,
sending the reference signal on limited to one or more subframes in a frame; or,
sending the reference signal on any one subframe in a frame, wherein
if the reference signal is not sent on continuous symbols, other reference signals, or data, or control information or reserved signals are filled on a middle symbol.

20. The apparatus according to claim 14, wherein the sending module sends the reference signal on a frequency domain by using the unlicensed carrier in following manners:
the reference signal being continuous or spaced at an interval of one or more Resource Elements, RE, or RBs;
or
the sending module sends the reference signal on a frequency domain by using the unlicensed carrier in following manners:
filling the reference signal from a middle of a system bandwidth to both sides; or, filling the reference signal from a low frequency band to a high frequency band of a system bandwidth.

21. (canceled)

22. The apparatus according to claim 14, wherein
the identification information of the operator comprises any one of: a Mobile Network Code, MNC, a PLMN ID, an ECGI, and re-numbered operator identification information; and
the designated reference signal comprises one or more of: a Primary Synchronization Signal, PSS, a Secondary Synchronization Signal, SSS, a Common Reference Signal, CRS, a Channel State Information-Reference Signal, CSI-RS, a Positioning Reference Signal, PRS, and a Downlink User Equipment-specific Reference Signal.
